(19) United States
(12) Patent Application Publication
(10) Pub. No.: US 2024/0390914 A1
(43) Pub. Date: Nov. 28, 2024

(54) MAINTENANCE PLATFORM FOR CONE CRUSHERS

(71) Applicant: Terex GB Limited, Dungannon (GB)

(72) Inventors: Stephen Sloan, Dungannon (GB); Karl Robinson, Ballygawley (GB)

(21) Appl. No.: 18/670,829

(22) Filed: May 22, 2024

(30) Foreign Application Priority Data
May 22, 2023 (GB) 2307659.9

(51) Int. Cl. B02C 23/00; B02C 2/04

(52) U.S. Cl. CPC B02C 23/00; B02C 2/04

(57) ABSTRACT

A maintenance platform for a cone crusher comprising a crushing head located within an outer structure. The maintenance platform comprises an annular outer portion for locating on the outer structure and deployable platform portions that are movable between a deployed state in which the deployable platform portions extend from the outer portion in an inward direction to provide a platform for accessing the crushing head, and a non-deployed state in which the deployable platform portions are retracted.

### FIELD OF THE INVENTION

This invention relates to maintenance platforms. The invention relates particularly to maintenance platforms for cone crushers.

### BACKGROUND TO THE INVENTION

Conventional cone crushers have a base part comprising a cone head located in a chamber formed by a main frame. The chamber is large enough to define a gap around the cone head for receiving crushed material during use. The cone head includes a liner, commonly referred to as a mantle liner or just mantle, which is subject to wear and needs replaced from time to time. The mantle is secured in place by a mantle nut located at the top of the cone head. The mantle nut must be unfastened in order to remove the mantle, and fastened once a new mantle is installed. However, because of the size of typical cone crushers, it is difficult for a human operator to reach the mantle nut. A common solution to this problem is to lay a plank from the rim of the main frame to the mantle and to stand on the plank to access the mantle nut. However, not only is this unstable, and therefore dangerous, but the plank also has to be removed before the mantle can be removed, and re-installed once the new mantle is fitted.

It would be desirable to mitigate the problems outlined above.

### SUMMARY OF THE INVENTION

From a first aspect the invention provides a maintenance platform for a crushing machine comprising a crushing head located within an outer structure, the maintenance platform comprising:
at least one outer portion that is configured to be removably located on the outer structure; and
at least one deployable platform portion that is movable with respect to said at least one outer portion between a deployed state in which said at least one deployable platform portion extends from said at least one outer portion in an inward direction to provide a platform for accessing the crushing head, and a non-deployed state in which said at least one deployable platform portion is relatively retracted in said inward direction.

In some embodiments, said at least one deployable platform portion is pivotable with respect to said at least one outer portion between said deployed state and said non-deployed state, said at least one deployable platform portion typically being pivotably coupled to said at least one outer portion.

Typically, said maintenance platform is annular or semi-annular or part-annular in shape.

Typically, said at least one outer portion is annular or semi-annular or part-annular in shape with respect to a notional central point, said inward direction being a direction from said at least one outer portion towards said notional central point, and wherein said at least one deployable platform portion is movable towards said notional central point to adopt said deployed state and away from said notional central point to adopt said non-deployed state.

In some embodiments, one or more respective deployable platform portion is coupled, preferably pivotably coupled, to a respective one of said at least one outer portion.

In some embodiments, said maintenance platform is annular, said at least one outer portion comprises a single annular outer portion, and said at least one deployable platform portion preferably comprises more than one deployable platform portion, each deployable platform portion preferably being coupled, more preferably pivotably coupled, to the outer portion.

In some embodiments, said maintenance platform is annular, said at least one outer portion comprises a plurality of outer portions, each outer portion being semi-annular or part-annular in shape, and said at least one deployable platform portion comprises at least one respective deployable platform portion for each outer portion, each deployable platform portion preferably being coupled, more preferably pivotably coupled, to the respective outer portion.

In preferred embodiments, said at least one outer portion comprises one or more outer portion, the, or each, outer portion being semi-annular or part-annular in shape, and said at least one deployable platform portion comprises at least one respective deployable platform portion for the, or each, outer portion, each deployable platform portion preferably being coupled, more preferably pivotably coupled, to the respective outer portion.

Typically, an obverse face of the, or each, outer portion is configured to provide an outer platform portion.

Preferably, the, or each, deployable platform portion is coplanar with, or substantially coplanar with, the respective outer portion when in the deployed state.

Preferably, an inner edge of the, or each, deployable platform portion is shaped to match the shape of the crushing head so that, in use when the platform portion is deployed, the inner edge fits around the crushing head.

In preferred embodiments, said at least one outer portion and said at least one deployable platform portion are concentrically arranged with said at least one platform portion being located inwardly of said at least one outer portion when said at least one platform portion is in the deployed state.

In preferred embodiments, at least one locating formation is provided at the underside of said at least one outer portion, and is configured to fit with, and/or be to engageable with, said outer structure when said at least one outer portion is located on said at least one outer structure, and wherein said at least one locating formation may include at least one locating formation for preventing or restricting lateral movement of said at least one outer portion, and/or at least one locating formation for preventing or restricting rotational movement of said at least one outer portion.

Preferably, said at least one deployable platform portion includes at least one engagement surface, and wherein at least one corresponding engagement surface is provided on the respective outer portion, the arrangement being such that, when the respective deployable platform portion is deployed, the respective engagement surfaces of the platform portion and respective outer portion engage with one another to hold the platform portion a deployed position.

From another aspect the invention provides a crushing machine assembly comprising:
a crushing head located within an outer structure; and
the maintenance platform of the first aspect of the invention,
   wherein said at least one outer portion is located on said outer structure,
   and wherein, in said deployed state said at least one deployable platform portion extends from said at least one outer portion in an inward direction towards said crushing head to provide a platform for accessing the crushing head, and in said non-deployed state, said at least one outer portion is relatively retracted with respect to said crushing head.

Preferably, said at least one outer portion and said at least one deployable platform portion are concentrically arranged wholly or partly around the crushing head.

Said outer structure typically comprises a rim that extends around said crushing head, and wherein said at least one outer portion is located on said rim. Said at least one outer portion may extend wholly or partly around said rim.

The maintenance platform is shaped and dimensioned so that, when said at least one deployable platform portion is in the deployed state, an inner edge of the, or each, platform portion is located adjacent, and in contact with or not in contact with, the crushing head.

In some embodiments, when said at least one deployable platform portion is in the deployed state, the maintenance platform closes or substantially closes the top of the outer structure around said crushing head.

In typical embodiments, when said at least one deployable platform portion is in the non-deployed state, a gap between the crushing head and the maintenance platform is larger than it is when said at least one deployable platform portion is in the deployed state.

In some embodiments, said crushing head comprises a mantle liner, and wherein, when said at least one deployable platform portion is in the non-deployed state, said gap is large enough to allow said mantle liner to pass through.

Optionally, when said at least one deployable platform portion is in the deployed state, said gap is not large enough to allow said mantle liner to pass through.

Preferably, said at least one deployable platform portion, or at least the respective obverse face of said at least one deployable platform portion, is horizontally disposed, or substantially horizontally disposed, when in the deployed state.

Preferably, said at least one outer platform portions, or at least the respective obverse face(s) of said at least one outer platform portion, is horizontally disposed, or substantially horizontally disposed, when mounted on the outer structure.

From another aspect the invention provides a crushing machine assembly comprising:
a crushing head located within an outer structure; and
a maintenance platform comprising at least one outer portion and at least one deployable platform portion that is movable with respect to said at least one outer portion between a deployed state and a non-deployed state,
   wherein said at least one outer portion is located on said outer structure,
   and wherein, in said deployed state said at least one deployable platform portion extends from said at least one outer portion in an inward direction towards said crushing head to provide a platform for accessing the crushing head, and in said non-deployed state, said at least one outer portion is relatively retracted with respect to said crushing head.

Other advantageous aspects of the invention will become apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1 is an isometric view of a base part of a cone crusher including a maintenance platform embodying the invention, the maintenance platform having deployable platform portions shown in a deployed state on FIG. 1;

FIG. 2 is an isometric view of the base part of FIG. 1 in which the deployable platform portions of the maintenance platform are shown in a non-deployed state;

FIG. 3 is an isometric view of the base part of FIG. 1 in which the deployable platform portions of the maintenance platform are shown in the non-deployed state and which shows a liner component of the cone crusher being removed;

FIG. 4 is an exploded isometric view of a first part of the maintenance platform shown in FIGS. 1 to 3;

FIG. 5 shows an isometric view of the underside of an outer portion of the maintenance platform shown in FIGS. 1 to 4;

FIG. 6 shows an isometric view of the underside of one of the deployable platform portions of the maintenance platform shown in FIGS. 1 to 4;

FIG. 7 shows an isometric view of part of the base part, including part of one of the deployable platform portions shown in the deployed state; and

FIG. 8 shows an isometric view of part of the base part, including an anti-rotation structure.

### DETAILED DESCRIPTION OF THE DRAWINGS

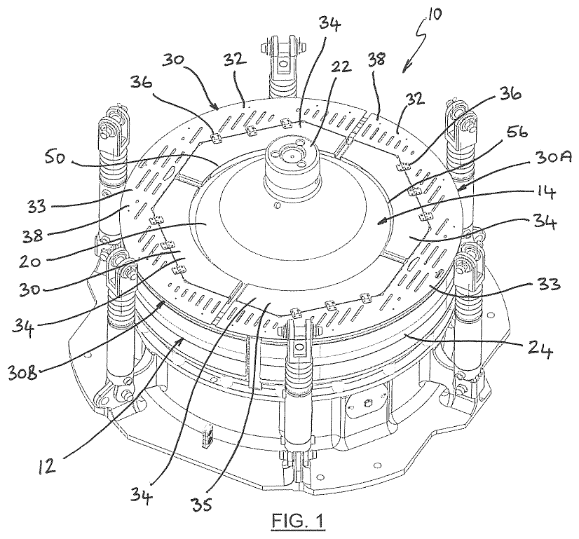

Referring now in particular to FIGS. 1 to 3 of the drawings there is shown, generally indicated as 10, a base part of a crushing machine. The base part 10 comprises a main frame 12 and a crushing head 14 located in a chamber 16 provided in the main frame 12. In typical embodiments the crushing machine is of a type commonly referred to as a cone crusher, the crushing head 14 being generally conical in shape and commonly referred to as a cone head. The chamber 16 is shaped and dimensioned to provide a gap 18 around the crushing head 14. During use, crushed material (not shown) passes through the gap 18 to an outlet (not shown) of the crushing machine. The main frame 12 typically comprises an annular wall 24 or other annular structure that extends around the crushing head 14 and provides the chamber 16.

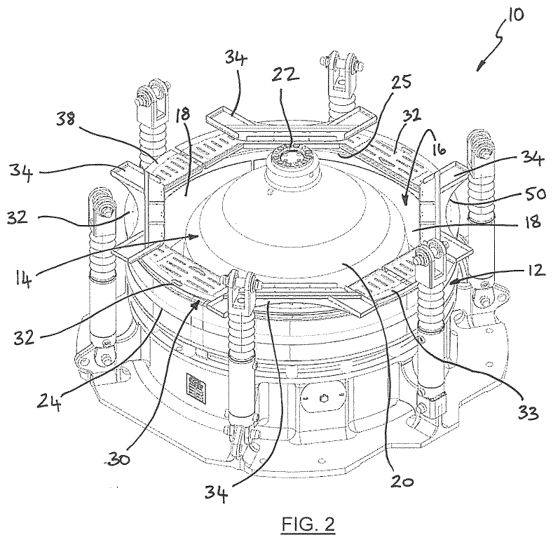

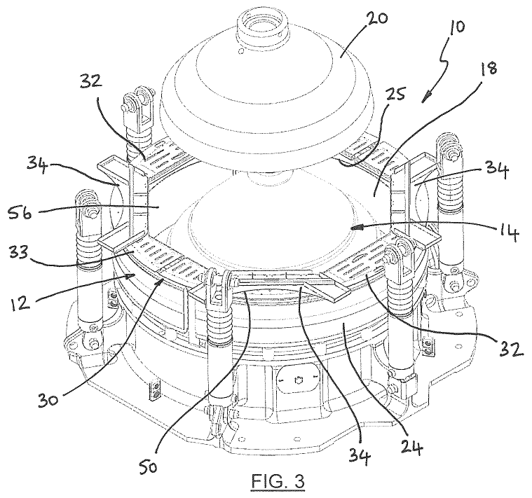

The crushing head 14 includes a liner 20, which is commonly referred to as the mantle liner, or just the mantle. In typical embodiments in which the crushing machine is a cone crusher, the mantle 20 is generally cone shaped. As can best be seen from FIG. 3, the mantle 20 is removable from the crushing head 14. The mantle 20 may be removed and replaced, e.g. when worn or damaged, or removed to allow access to the rest of the crushing head 14, e.g. for maintenance or repair. A releasable fastening device 22 (FIG. 2), commonly referred to as the mantle nut, is provided to releasably fasten the mantle 20 to the crushing head 14. Typically, the fastening device 22 is provided at the top of the crushing head 14. The fastening device 22 is typically protected by a cover 23 (FIG. 1), commonly referred to as the mantle cap, that is removable in order to access the fastening device 22.

A drive mechanism (not shown) may be coupled to or incorporated into the base part 10, and be configured to rotate the crushing head 14. The drive mechanism may take any conventional form.

The crushing machine includes an upper part (not shown) that is located on top of the base part 10 during use, and which may be removed (as shown in FIGS. 1 to 3) to facilitate maintenance. The upper part includes an annular wall or other annular structure that extends around the crushing head 14 when the upper part is fitted to the base part 10 to define a crushing chamber (not shown) that is located above, and opens into, the chamber 16. The inner surface of the annular wall of the upper part is typically provided with a removable liner. In the case of a cone crusher, the inner surface of the annular wall of the upper part is generally conical, in particular to match or at least be compatible with, the shape of the cone head 14, in which case the annular wall of the upper structure is commonly referred to as a concave, and its liner is commonly referred to as the concave liner. In the crushing chamber, an annular crushing gap is provided between the crushing head 14 and the annular wall of the upper part. The upper part includes an inlet for material to be crushed, optionally comprising a chute or hopper.

In use, material to be crushed is fed into the crushing machine via the inlet of the upper part whereupon it enters the crushing chamber and is crushed between the crushing head 14 and the annular wall of the upper part (or more particularly between the respective liners) as a result of rotational movement of the crushing head 14. Typically, the crushing head 14 is irregularly, or eccentrically, shaped such that, as it rotates, it creates a crushing action between itself and the crushing chamber. Crushed material passes into the chamber 16 and is directed to the outlet of the crushing machine.

In FIGS. 1 to 3, a maintenance platform 30 embodying the invention is shown installed, preferably removably, on the base part 10 of the crushing machine. In preferred embodiments, the platform 30 is located on an upper rim 25 of the annular wall 24 that extends around the crushing head 14. The platform 30 may be fastened to the annular wall 24 and any conventional fastening means, preferably releasable fastening means. In preferred embodiments, however, the platform 30 rests on the wall 24, conveniently on the upper rim 25, without fastening. In either case, the platform 30 is conveniently supported by the wall 24.

In preferred embodiments, the platform 30 is annular, or ring-shaped. In particular, it is preferred that the platform 30 is shaped and dimensioned to extend around the entire upper rim 25 and so to extend entirely around the crushing head 14 during use. Alternatively, the platform 30 may be configured to extend only partly around the rim 25, and only partly around the crushing head 14. For example, the platform 20 may be semi-annular or part-annular in shape, e.g. C-shaped, arc-like or concave in shape. Optionally, the platform 30 may be provided in a plurality of parts, each part being arc-like, semi-annular or otherwise part-annular or concave in shape, e.g. C-shaped, the configuration being such that two or more parts may be installed on the rim 25, preferably side-by-side, but optionally spaced-apart, such that the platform 30 extends wholly or partly around the rim 25. For example, in the illustrated embodiment, the platform 30 comprises first and second parts 30A, 30B, each being semi-annular, or C-shaped. Optionally, when installed on the base part 10, each part of the platform 30 may be connected to the, or each, adjacent part. Any conventional releasable connector may be used for this purpose. Providing the platform in two or more parts facilitates installation and removal of the platform 30.

The platform 30 comprises at least one outer portion 32 and at least one deployable platform portion 34, typically a plurality of deployable platform portions 34. In embodiments in which there is more than one deployable platform portion 34, the platform portions 34 are preferably located side-by-side. In embodiments in which the platform 30 comprises multiple parts 30A, 30B, each part preferably has one outer portion 32 and one or more deployable platform portions 34. For example, in the illustrated embodiment, each part 30A, 30B has a single outer portion 32 and two deployable platform portions 34. In embodiments in which the platform 30 is not provided in parts, it may comprise a single annular outer portion 32 and at least one, typically more than one, deployable platform portion 34.

Each deployable platform portion 34 is movable with respect to the respective outer portion 32 between a deployed state (as shown in FIG. 1) and a non-deployed state (as shown in FIGS. 2 and 3). In the deployed state the, or each, platform portion 34 adopts a position in which it extends from the respective outer portion 32 in an inward direction (which is towards the crushing head 14 in use) and is configured to serve as a platform for facilitating access to the crushing head 14, in particular the fastening device 22. In preferred embodiments, the platform portion 34 is coplanar with, or substantially coplanar with, the respective outer portion 32 when in the deployed state (or at least their respective obverse faces 35, 33 are coplanar or substantially coplanar), although it may be inclined with respect to the outer portion 32 (e.g. such that the obverse face 35 of the platform portion 34 makes an angle of more than 135 degrees with respect to the obverse face 33 of the outer portion 32). In the non-deployed state, the, or each platform portion 34, adopts a relatively retracted position in comparison with the deployed state. In particular, in the non-deployed state, each platform portion 34 is relatively retracted in the inward direction (or less extended in the inward direction in comparison with the deployed state) so that, in use, a larger gap 56 is provided between each platform portion 34 and the crushing head 14 than is present when the platform portion(s) 34 are in the deployed state. In typical embodiments, in the non-deployed state, the platform portion 34 is folded, pivoted or otherwise retracted with respect to the outer portion so that, in use, it does not obstruct removal of the mantle 20. In preferred embodiments, when moving from the non-deployed state to the deployed state, each platform portion 34 moves in an inward direction (i.e. towards the crushing head 14 during use), and when moving from the deployed state to the non-deployed state, each platform portion 34 moves in an outward direction (i.e. away from the crushing head 14 during use).

More generally, the or each outer portion 32 may be annular or semi-annular or part-annular in shape with respect to a notional central point, the inward direction being a direction from the respective outer portion towards the notional central point. Each deployable platform portion 34 is movable towards the notional central point (i.e. towards the crushing head 14 in use) when moving from the non-deployed state to the deployed state, and away from the notional central point when moving from the deployed state to the non-deployed state.

In preferred embodiments, and as can best be seen from FIGS. 1 to 3, each platform portion 34 is pivotably coupled to the respective outer portion 32. The pivotable coupling may be effecting using any convenient coupling means, e.g. one or more hinge 36 or other pivot joint. Preferably, the configuration is such that, in the non-deployed state, the platform portion 34 is folded or pivoted on top of the respective outer portion 32 (as for example is illustrated in FIGS. 2 and 3). To this end, the pivotable coupling may be configured to allow the platform portion 34 to pivot or fold through 180° (or more) between the deployed and non-deployed states. Alternatively, in the non-deployed state the platform portion 34 may be inclined with respect to the outer portion 32 (e.g. such that the obverse face 35 of the platform portion 34 makes an angle of up to 135 degrees with respect to the obverse face 33 of the outer portion 32). It is preferred however that the platform portion is foldable or pivotable through at least 90° between the deployed and non-deployed states.

In alternative embodiments (not illustrated), the, or each, platform portion 34 may be coupled to the respective outer portion 32 in any other convenient manner. For example, each platform portion 34 may be coupled to the respective outer portion 32 for relative linear movement between the platform portion 34 and outer portion (e.g. by a sliding coupling or roller coupling). Alternatively, still each platform portion 34 may be removably coupled to the respective outer portion 32 so that it can be removed when not deployed.

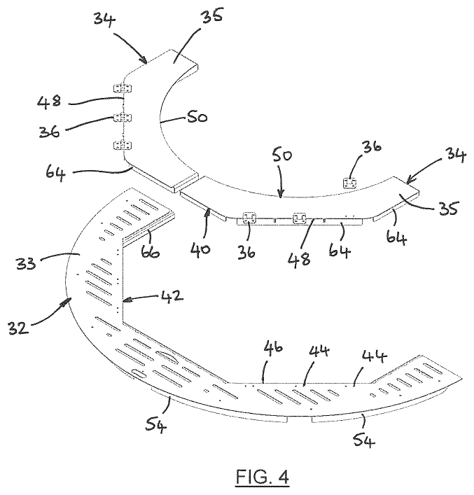

FIG. 4 is an exploded isometric view of the part 30A of the maintenance platform 30. Part 30B may be the same as part 30A. In this example, the outer portion 32 is semi-annular, in particular semi-circular or substantially semi-circular. This shape is particularly suited for fitting to base parts 10 in which the rim 25 is circular or substantially circular, which is common as the crushing head 14 typically is circular or generally circular in transverse cross section. In other embodiments, the outer portion 32 may take other shapes, in particular to suit the shape of the rim 25 to which it is intended to be fitted. The outer portion 32 may be formed from any suitable material, typically metal, e.g. steel or aluminium.

In preferred embodiments, the outer portion 32, in particular the obverse face 33 of the outer portion 32, is configured to provide an outer platform portion 38. To this end, the obverse face 33 of the outer portion 32 is preferably planar or substantially planar. The obverse face 33 preferably extends along the entire length of the outer portion 32, but may alternatively extend only partly along the length of the outer portion 32. The obverse face 33 preferably has a width or depth suitable for supporting an operator's feet, e.g. preferably at least 10 cm.

In the example of FIG. 4, the part 30A includes first and second deployable platform portions 34A, 34B. In this example, each platform portion 34A, 34B is arc-like or part-annular in shape. In other embodiments, the platform portion(s) 34 may take other shapes, in particular to suit the shape of the outer portion 32 to which it is intended to be coupled and preferably also to match the shape of, or at least be suited to fitting around, the crushing head 14 with which it is intended to be used. Typically, each platform portion 34 is annular, semi-annular or part-annular in shape, e.g. arc-like or concave in shape. Each deployable platform portion 34 may be formed from any suitable material, typically metal, e.g. steel or aluminium.

Each deployable platform portion 34 has an obverse face 35 that provides a platform surface when in the deployed state. The obverse face 35 is preferably planar or substantially planar. The obverse face 35 preferably extends along the entire length of the platform portion 34, but may alternatively extend only partly along the length of the platform portion 34. The obverse face 35 preferably has a width or depth suitable for supporting an operator's feet, e.g. preferably at least 10 cm.

In preferred embodiments, an outer part, conveniently an outer edge 40, of each deployable platform portion 34 is coupled to an inner part, conveniently an inner edge 42, of the respective outer portion 32. In the illustrated embodiment, the coupling is effected by hinges 36 (in FIG. 4 the hinges 36 are shown fitted to the platform portions 34 and apertures 44 are shown in the outer portion 32 for receiving screws or other fixings for fixing the hinges 36 to the outer portion 34). Conveniently, the outer edge 40 of each deployable platform portion 34 is shaped to match the inner edge 42 of the outer portion 32, in particular the part of the inner edge 42 to which it is coupled. Typically, the outer edge 40 of the deployable platform portion 34 is convex and the inner edge 42 of the outer portion 32 is concave. The preferred configuration is such that the shape of outer edges 40 of the platform portions 34 together match the shape of the inner edge 42 of the respective outer portion 32, in particular when the platform portions 34 are deployed and side-by-side. In typical embodiments where the outer portion 32 is provided in two or more parts 30A, 30B, the inner edge 42 of the outer portion 32 is typically semi-annular or part-annular in shape, e.g. C-shaped, arc-like, or concave in shape, and typically matches or substantially matches the overall shape of the respective part 30A, 30B. In embodiments where the outer portion 32 comprises a single part, the inner edge 42 of the outer portion 32 is typically annular, and may be circular but preferably comprises one or more straight portions. Optionally, the inner edge 42 of the outer portion 32 and the outer edge 40 of the deployable platform portion 34 include one or more respective corresponding straight portion 46, 48 where the outer portion 32 and platform portion 34 are coupled together. The provision of the straight portions 46, 48 facilitates the provision of more than one hinge 36, or other pivot joint, aligned to provide a common pivot axis.

In preferred embodiments, the inner edge 50 of each deployable platform portion 34 is shaped to match the shape of, or at least be suited to fitting around, the crushing head 14 so that, in use when the platform portion 34 is deployed, the inner edge 50 fits around the crushing head 14. The arrangement preferably allows a close fit between the platform portion 34 and the crushing head 14. The inner edge 50 of each platform portion 34 may be semi-circular or arc-like (e.g. depending on how may platform portions 34 there are) or otherwise curved or shaped to match the outer surface of the crushing head 14. It will be understood that shape the inner edge 50 does not need to exactly match the shape of the outer surface of the crushing head.

In preferred embodiments, the outer edge 52 of the platform 30 is circular. In embodiments in which the platform comprises multiple parts 30A, 30B, the outer edge 52 of each part may be semi-circular or arc-like depending on how many parts there are. The outer edge 52 may take other shapes as is convenient.

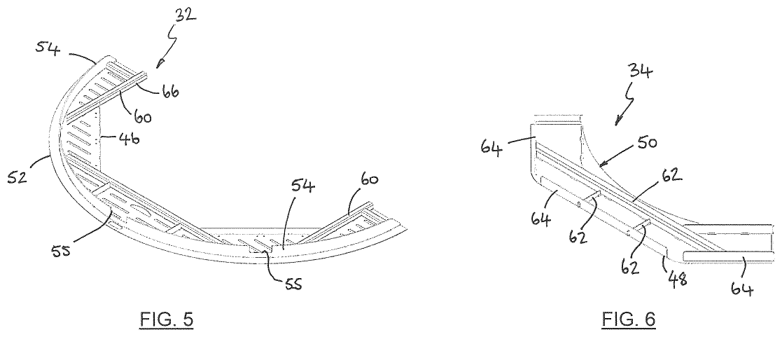

FIG. 5 shows an isometric view of the underside of the part 30A of the maintenance platform 30. Part 30B may be the same as part 30A.

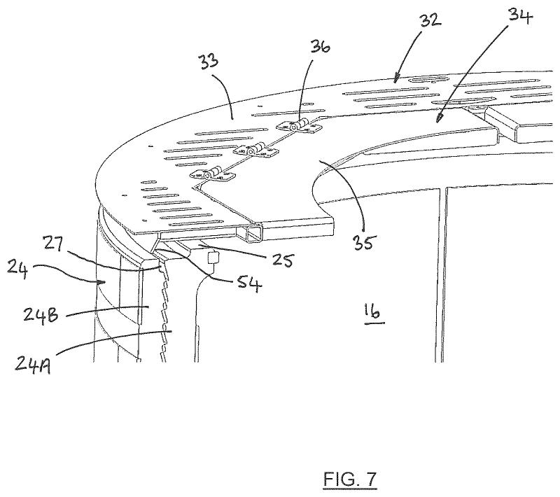

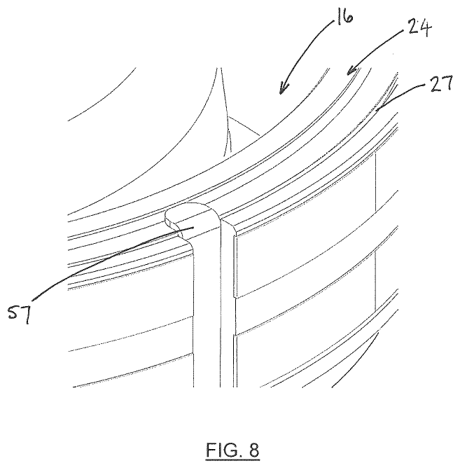

In preferred embodiments, the, or each, outer portion 32 includes at least one locating formation 54 for locating the outer portion 32 with respect to the rim 25. The locating formation(s) 54 may comprise a flange or one or more other formations that project from the underside of the outer portion 32. In preferred embodiments, the locating formation(s) 54 are configured (e.g. shaped, dimensioned and positioned, as required) to fit with, and/or be to engageable with, at least one surface of the annular wall 24 of the main frame 12 when the platform 30 is located on the rim 25. In particular, the annular wall 24 may be configured to include one or more recess 27 (FIG. 7) in the rim 25, the locating formation(s) 54 being configured to fit into the recess(es) 27 when the outer portion 32 is located on the rim 25. In typical embodiments, the recess 27 comprises a channel that extends at least partly, or fully, around the rim 25. For example, the recess 27 may be formed between a wall 24A of the chamber 16 and an outer ring 24B (which may be referred to as a wedge ring 24B) fitted to the outside of the wall 24A. In preferred embodiments, the formation 54 comprises a flange, rib, collar or other projection that extends at least partly, or fully, around the underside of the outer portion 32, and which may be semi-annular, in particular semi-circular or substantially semi-circular, in shape. Advantageously. The arrangement is such that the locating formation(s) 54 are engageable with the annular wall 24 (e.g. with the wall(s) of the recess(es) 27 if present, or the outer or inner surface of the wall 24 depending on the configuration) in order to prevent or restrict lateral movement of the outer portion 32 with respect to the base part 10 or wall 24.

In preferred embodiments, the locating formation(s) 54 include one or more anti-rotation formation 55 for engagement with one or more corresponding anti-rotation formation 57 (FIG. 8) provided on the base part 10 in order to restrict or prevent rotational movement of the outer portion 32 with respect to the base part 10 (in the plane of the rim 25). In preferred embodiments, the anti-rotation formation(s) 55 comprise one or more recess in the formation 54, or gap(s) between adjacent formations 54. The corresponding anti-rotation formation 57 may comprise a post, bar or any formation or structure that is configured to fit together with a respective formation 55 when the outer portion 32 is located on the rim 25. In the example illustrated in FIG. 8, the formation 57 comprises a structure, e.g. a post or bar, that extends across the recess 27. The outer portion 32 is located on the wall 24 such that the, or each, instance of corresponding formations 55, 57 fit together (e.g. the formation 57 fits into the formation 55 in the illustrated example) in order to restrict or prevent rotational movement of the outer portion 32.

The underside of the outer portion 32 has a surface for engaging with the upper surface of the rim 25. The engaging surface of the outer portion 32 is preferably planar. In preferred embodiments, the engaging surface of the outer portion 32 is provided by the respective outer most surface (i.e. the bottom-most surface in use) of at least one, but typically a plurality of, support structures 60 (e.g. strut(s), bars or the like, preferably being hollow section structure(s)). The outer most surfaces of the structures 60 are aligned with each other to provide a planar or substantially planar engaging surface for resting on the rim 25. The preferred arrangement is such that the engaging surface provides multiple engagement locations (preferably at least three) with the rim 25. By way of example the support structures 60 may be arranged to provide triangularly spaced apart engagement locations with the rim 25.

In preferred embodiments, the outer portion 32 comprises a plate or sheet of suitable material (e.g. steel or aluminium), the obverse face 33 of which provides the outer platform portion 38. The support structure(s) 60 may be fixed to the underside of the plate or sheet in any conventional manner.

In preferred embodiments, the locating formation(s) 54 are dimensioned to extend beyond the engaging surface of the outer portion 32, i.e. beyond the bottom-most surface(s) of the support structure(s) 60 in preferred embodiments, in the direction away from the underside of the outer portion 32. This facilitates the location formation(s) 54 performing the locating function described above while the engaging surface rests on the rim 25.

In preferred embodiments, at least the outer portion 32, and preferably the outer portion 32 together with the respective deployable platform portion(s) 34, are configured to have a centre of gravity, or centre of mass, that is located within the lateral boundaries of the outer portion 32, preferably within the engaging surface of the outer portion. This arrangement helps to ensure that the platform does not topple off the rim 25.

FIG. 6 shows an isometric view of the underside of one of the deployable platform portions 34 of the maintenance platform 30. In preferred embodiments, each platform portion 34 comprises a plate or sheet of suitable material (e.g. steel or aluminium), the obverse face 35 of which provides the respective platform. One or more support structure(s) 62 may be fixed to the underside of the plate or sheet in any conventional manner.

In preferred embodiments, each platform portion 34 includes at least one engagement surface 64 at the outer edge 40 that extends downwardly, preferably perpendicularly or substantially perpendicularly to the obverse face 35. At least one corresponding engagement surface 66 may be provided at the respective inner edge 42 of the outer portion 32, which also extends downwardly, preferably perpendicularly or substantially perpendicularly to the obverse face 33. The engagement surfaces 64, 66 may be provided by any convenient formation or structure. For example, each engagement surface 64 may be provided by a flange or folded section. Each engagement surface 66 may conveniently be provided by a surface of the support structure 60. The arrangement is such that, when the platform portion 34 is deployed, the respective engagement surfaces 64, 66 engage with one another to hold the platform portion 34 in its desired deployed position, which is preferably such that the surfaces 33, 35 are coplanar or substantially coplanar with each other.

Referring again to FIGS. 1 to 3 in particular, with the upper part (not shown) of the crushing machine removed, the platform 30 is installed on the base part 10. The, or each, outer portion 32 is located on, and supported by, the rim 25. In preferred embodiments, the arrangement is such that the outer portion 32, or the outer portions collectively when there is more than one, extend around the entire rim 25 and therefore entirely around the crushing head 14.

In FIG. 1, the deployable platform portions 34 are in the deployed state. As such, the platform portions 34, in particular the obverse faces 35 of the platform portions 34, provide a platform that facilitates the operator reaching the crushing head 14, in particular the fastening device 22. In preferred embodiments, the platform 30 is shaped and dimensioned so that, when the platform portions 34 are in the deployed state, the inner edge 50 of each platform portion 34 is located adjacent, or contacts, the crushing head 14; it is preferred that any gap 56 between the crushing head 14 and the platform 30 is minimized. In preferred embodiments, when the platform portions 34 are in the deployed state, the platform 30 closes or substantially closes the otherwise open top of the base part 10. More generally, when the platform portions 34 are in the deployed state the gap 56 (which is typically annular) is not large enough to allow the mantle 20 to pass through it and, as such, the platform 30 obstructs removal of the mantle 20 when the platform portions 34 are deployed.

Preferably, the arrangement is such that the platform portions 34, or at least the obverse faces 35 of the platform portions 34, are horizontally disposed, or substantially horizontally disposed when in the deployed state.

In preferred embodiments, the, or each, outer portion 32, in particular its obverse face, provides part of the overall platform surface. In particular, when in the deployed state, the or each deployable platform portion 34 and the respective outer platform portion 38 together provide the platform on which the operator can stand or otherwise be supported in order to reach the relevant parts of the crushing head 14. Preferably, the arrangement is such that the outer platform portions 38, or at least the obverse faces 33 of the outer platform portions 38, are horizontally disposed, or substantially horizontally disposed when mounted on the rim 25. Preferably, the platform portions 34, or at least the obverse faces 35 of the platform portions 34, and the outer platform portions 38, or at least the obverse faces 33 of the outer platform portions 38, are coplanar or substantially coplanar when the platform portions 34 are in the deployed state.

In preferred embodiments, the outer portion(s) 32 and deployable platform portions 34 are concentrically arranged, in particular when the deployable platform portions 34 are deployed, with the platform portions 34 being located inwardly of the outer portion(s) 32. In use, the outer portion(s) 32 and deployable platform portions 34 are concentrically arranged around the crushing head 14.

In FIGS. 2 and 3, the deployable platform portions 34 are shown in the non-deployed state. In the illustrated embodiment, this involves pivoting or folding the platform portions 34 via hinges 36 until they are located on top of the respective outer portion 32. When the platform portions 34 are in the non-deployed state, the gap 56 between the crushing head 14 and the platform 30 is larger than it is when the platform portions 34 are in the deployed state. The platform 30 is shaped and dimensioned such that the gap 56 (which is typically annular (but not typically circular as a result of the irregularly or eccentrically shaped crushing head) is large enough for the mantle 20 to be removed (typically by being lifted vertically upwards as shown in FIG. 3, e.g. using a crane (not shown) when the platform portions 34 are in the non-deployed state. Similarly, when the platform portions 34 are in the non-deployed state, the mantle 20 (or a replacement mantle) can be installed through the gap 56.

Advantageously, because the gap 56 is large enough to allow the mantle 20 to be removed or installed when the platform portions 34 are in the non-deployed state, the platform 30 can remain on the base part 10 while the mantle 20 is removed and/or installed. Once any necessary maintenance tasks are performed, the platform 30 may be removed from the base part 10 and the upper part of the crushing machine may be installed.

The invention is not limited to the embodiment(s) described herein but can be amended or modified without departing from the scope of the present invention.

1. A maintenance platform for a crushing machine comprising a crushing head located within an outer structure, the maintenance platform comprising:
at least one outer portion that is configured to be removably located on the outer structure; and
at least one deployable platform portion that is movable with respect to said at least one outer portion between a deployed state in which said at least one deployable platform portion extends from said at least one outer portion in an inward direction to provide a platform for accessing the crushing head, and a non-deployed state in which said at least one deployable platform portion is relatively retracted in said inward direction.

2. The maintenance platform of claim 1, wherein said at least one deployable platform portion is pivotable with respect to said at least one outer portion between said deployed state and said non-deployed state, said at least one deployable platform portion typically being pivotably coupled to said at least one outer portion.

3. The maintenance platform of claim 1, wherein said maintenance platform is annular or semi-annular or part-annular in shape, and wherein, preferably, said at least one outer portion is annular or semi-annular or part-annular in shape with respect to a notional central point, said inward direction being a direction from said at least one outer portion towards said notional central point, and wherein said at least one deployable platform portion is movable towards said notional central point to adopt said deployed state and away from said notional central point to adopt said non-deployed state.

4. The maintenance platform of claim 1, wherein one or more respective deployable platform portion is coupled, preferably pivotably coupled, to a respective one of said at least one outer portion.

5. The maintenance platform of claim 1, wherein said maintenance platform is annular, said at least one outer portion comprises a single annular outer portion, and said at least one deployable platform portion preferably comprises more than one deployable platform portion, each deployable platform portion preferably being coupled, more preferably pivotably coupled, to the outer portion.

6. The maintenance platform of claim 1, wherein said maintenance platform is annular, said at least one outer portion comprises a plurality of outer portions, each outer portion being semi-annular or part-annular in shape, and said at least one deployable platform portion comprises at least one respective deployable platform portion for each outer portion, each deployable platform portion preferably being coupled, more preferably pivotably coupled, to the respective outer portion.

7. The maintenance platform of claim 1, wherein said at least one outer portion comprises one or more outer portion, the, or each, outer portion being semi-annular or part-annular in shape, and said at least one deployable platform portion comprises at least one respective deployable platform portion for the, or each, outer portion, each deployable platform portion preferably being coupled, more preferably pivotably coupled, to the respective outer portion.

8. The maintenance platform of claim 1, wherein an obverse face of the, or each, outer portion is configured to provide an outer platform portion.

9. The maintenance platform of claim 1, wherein the, or each, deployable platform portion is coplanar with, or substantially coplanar with, the respective outer portion when in the deployed state.

10. The maintenance platform as claimed in claim 1, wherein an inner edge of the, or each, deployable platform portion is shaped to match the shape of the crushing head so that, in use when the platform portion is deployed, the inner edge fits around the crushing head.

11. The maintenance platform as claimed in claim 1, wherein said at least one outer portion and said at least one deployable platform portion are concentrically arranged with said at least one platform portion being located inwardly of said at least one outer portion when said at least one platform portion is in the deployed state.

12. The maintenance platform as claimed in claim 1, wherein at least one locating formation is provided at the underside of said at least one outer portion, and is configured to fit with, and/or be to engageable with, said outer structure when said at least one outer portion is located on said at least one outer structure, and wherein said at least one locating formation may include at least one locating formation for preventing or restricting lateral movement of said at least one outer portion, and/or at least one locating formation for preventing or restricting rotational movement of said at least one outer portion.

13. The maintenance platform as claimed in claim 1, wherein said at least one deployable platform portion includes at least one engagement surface, and wherein at least one corresponding engagement surface is provided on the respective outer portion, the arrangement being such that, when the respective deployable platform portion is deployed, the respective engagement surfaces of the platform portion and respective outer portion engage with one another to hold the platform portion a deployed position.

14. A crushing machine assembly comprising:
a crushing head located within an outer structure; and
a maintenance platform comprising at least one outer portion and at least one deployable platform portion that is movable with respect to said at least one outer portion between a deployed state and a non-deployed state,
wherein said at least one outer portion is located on said outer structure,
and wherein, in said deployed state said at least one deployable platform portion extends from said at least one outer portion in an inward direction towards said crushing head to provide a platform for accessing the crushing head, and in said non-deployed state, said at least one outer portion is relatively retracted with respect to said crushing head.

15. The crushing machine assembly of claim 14, wherein said at least one outer portion and said at least one deployable platform portion are concentrically arranged wholly or partly around the crushing head.

16. The crushing machine assembly of claim 14, wherein said outer structure comprises a rim that extends around said crushing head, and wherein said at least one outer portion is located on said rim, and wherein, preferably, said at least one outer portion extends wholly or partly around said rim.

17. The crushing machine assembly as claimed in claim 14, wherein the maintenance platform is shaped and dimensioned so that, when said at least one deployable platform portion is in the deployed state, an inner edge of the, or each, platform portion is located adjacent, or in contact with or not in contact with, the crushing head.

18. The crushing machine assembly as claimed in claim 14, wherein, when said at least one deployable platform portion is in the deployed state, the maintenance platform closes or substantially closes the top of the outer structure around said crushing head.

19. The crushing machine assembly as claimed in claim 14, wherein, when said at least one deployable platform portion is in the non-deployed state, a gap between the crushing head and the maintenance platform is larger than it is when said at least one deployable platform portion is in the deployed state, and wherein, preferably, said crushing head comprises a mantle liner, and wherein, when said at least one deployable platform portion is in the non-deployed state, said gap is large enough to allow said mantle liner to pass through, and wherein, preferably, when said at least one deployable platform portion is in the deployed state, said gap is not large enough to allow said mantle liner to pass through.

20. The crushing machine assembly of claim 14 wherein said at least one deployable platform portion, or at least the respective obverse face of said at least one deployable platform portion, is horizontally disposed, or substantially horizontally disposed, when in the deployed state, and/or wherein said at least one outer platform portions, or at least the respective obverse face(s) of said at least one outer platform portion, is horizontally disposed, or substantially horizontally disposed, when mounted on the outer structure.
